(19) United States
(12) Patent Application Publication
(10) Pub. No.: US 2020/0019702 A1
(43) Pub. Date: Jan. 16, 2020

(54) A HYBRID APPROACH OF MALWARE DETECTION

(71) Applicant: Nokia Technologies Oy, Espoo (FI)

(72) Inventors: Fei Tong, Xi'an Shaanxi (CN); Zheng Yan, Espoo (FI)

(73) Assignee: Nokia Technologies Oy, Espoo (FI)

(21) Appl. No.: 16/088,136

(22) PCT Filed: Mar. 25, 2016
(86) PCT No.: PCT/CN2016/077374

§ 371 Date: Sep. 25, 2018

(51) Int. Cl. G06F 21/56; G06F 16/84; H04L 29/06

(52) U.S. Cl. CPC G06F 21/56; H04L 63/145; G06F 16/84

(57) ABSTRACT

Method and apparatus are disclosed for malware detection. According to an embodiment, a hybrid method for malware detection comprises: obtaining calling maps of a malware set and a normal application set, wherein a calling map comprises information about system call sequences with different calling depth greater than or equal to one; generating a malware pattern set and a normal pattern set, based on comparison between frequencies of the calling maps of the malware set and the normal application set; acquiring a calling map of an unknown application; and determining a malware detection result for the unknown application, based on comparison between the unknown application's calling map with the malware pattern set and the normal pattern set. The malware pattern set and/or the normal pattern set may be updated according to the malware detection result.

### FIELD OF THE INVENTION

Embodiments of the disclosure generally relate to computer and network security, and, more particularly, to malware detection.

### BACKGROUND

Mobile device has evolved into an open platform for executing various applications. Mobile applications enhance many of our daily tasks by providing instant access to the wealth of information over the Internet and offering various functionalities. The fast growth of mobile applications plays a crucial role for the success of future mobile Internet and economy. About 2,000 new applications are shipped into markets every day.

Due to the rapid growth of the smart phone industry and the rapid promotion of 4G mobile communication technologies, more and more consumers use smart phones to access the Internet and consume various services. The smart phones normally store privacy user data such as pictures, messages, and personal credentials. Thus, the security of smart phones has been paid special attention. In the smart phone industry, devices with Android operating system hold a leading position. More seriously, around 97% of mobile malwares target the Android phones. In recent years, Android mobile security incidents occur frequently, and some serious attacks happen also at Apple phones.

In view of this, it would be advantageous to provide a way to allow for accurate and effective malware detection.

### SUMMARY

This summary is provided to introduce a selection of concepts in a simplified form that are further described below in detailed description. This summary is not intended to identify key features or essential features of the claimed subject matter, nor is it intended to be used to limit the scope of the claimed subject matter.

According to one aspect of the disclosure, it is provided a method comprising: obtaining calling maps of a malware set and a normal application set, wherein a calling map comprises information about system call sequences with different calling depth greater than or equal to one; generating a malware pattern set and a normal pattern set, based on comparison between frequencies of the calling maps of the malware set and the normal application set; acquiring a calling map of an unknown application; and determining a malware detection result for the unknown application, based on comparison between the unknown application's calling map with the malware pattern set and the normal pattern set.

According to another aspect of the disclosure, the method further comprises: updating the malware pattern set and/or the normal pattern set according to the malware detection result.

According to another aspect of the disclosure, the calling map is related to file system operations and/or network access.

According to another aspect of the disclosure, the step of obtaining comprises: running an application in a virtual environment; intercepting, for the application, information about called system calls; collecting, for the application, information about calling process; and deriving, for the application, a calling map from the intercepted information and collected information.

According to another aspect of the disclosure, the step of acquiring comprises: in response to a sample of the unknown application from a mobile device, running the sample in a virtual environment; intercepting, for the sample, information about called system calls; collecting, for the sample, information about calling process; and deriving, for the sample, a calling map from the intercepted information and collected information.

According to another aspect of the disclosure, the step of generating comprises: calculating a first frequency of a system call sequence in the malware set; calculating a second frequency of the system call sequence in the normal application set; and judging the system call sequence as a malware pattern or a normal pattern, based on comparison between the first and second frequencies.

According to another aspect of the disclosure, the step of judging comprises: judging the system call sequence as a malware pattern, when a first ratio between the first frequency and the second frequency is greater than a first threshold; and judging the system call sequence as a normal pattern, when a second ratio between the second frequency and the first frequency is greater than a second threshold.

According to another aspect of the disclosure, the step of determining comprises: determining the malware detection result, based on the first and second frequencies of a first intersection between the unknown application's calling map and the malware pattern set and a second intersection between the unknown application's calling map and the normal pattern set.

According to another aspect of the disclosure, the step of determining comprises: calculating a first sum of the first ratios of the first intersection; calculating a second sum of the second ratios of the second intersection; determining the unknown application as a malware, when the first sum is greater than a third threshold and the second sum is smaller than a fourth threshold; determining the unknown application as a normal application, when the first sum is smaller than the third threshold and the second sum is greater than the fourth threshold; and determining the unknown application as uncertain, when the first sum is greater than the third threshold and the second sum is greater than the fourth threshold, or when the first sum is smaller than the third threshold and the second sum is smaller than the fourth threshold.

According to another aspect of the disclosure, it is provided a method comprising: acquiring a calling map of an unknown application, wherein the calling map comprises information about system call sequences with different calling depth greater than or equal to one; and determining a malware detection result for the unknown application, based on comparison between the calling map with a malware pattern set and a normal pattern set, wherein the malware pattern set and the normal pattern set are generated by a security service provider (SSP) based on comparison between frequencies of calling maps of a malware set and a normal application set. The SSP can be located inside a system running the unknown application or in a remote detection server.

According to another aspect of the disclosure, the method further comprises: sending the malware detection result and the calling map of the unknown application to the SSP, such that the SSP can update the malware pattern set and/or the normal pattern set.

According to another aspect of the disclosure, the calling map is related to file system operations and/or network access.

According to another aspect of the disclosure, the step of acquiring comprises: running the unknown application in an isolated environment; intercepting, for the unknown application, information about called system calls; collecting, for the unknown application, information about calling process; and deriving, for the unknown application, a calling map from the intercepted information and collected information.

According to another aspect of the disclosure, each pattern in the malware pattern set and the normal pattern set has a first frequency in the malware set and a second frequency in the normal application set; wherein the step of determining comprises: determining the malware detection result, based on the first and second frequencies of a first intersection between the calling map and the malware pattern set and a second intersection between the calling map and the normal pattern set.

According to another aspect of the disclosure, the step of determining comprises: calculating a first sum of first ratios of the first intersection, the first ratio being a ratio between the first frequency and the second frequency of a pattern; calculating a second sum of second ratios of the second intersection, the second ratio being a ratio between the second frequency and the first frequency of a pattern; determining the unknown application as a malware, when the first sum is greater than a third threshold and the second sum is smaller than a fourth threshold; determining the unknown application as a normal application, when the first sum is smaller than the third threshold and the second sum is greater than the fourth threshold; and determining the unknown application as uncertain, when the first sum is greater than the third threshold and the second sum is greater than the fourth threshold, or when the first sum is smaller than the third threshold and the second sum is smaller than the fourth threshold.

According to another aspect of the disclosure, it is provided an apparatus comprising: at least one processor; and at least one memory including computer-executable code, wherein the at least one memory and the computer-executable code are configured to, with the at least one processor, cause the apparatus to perform all steps of any one of the above described methods.

According to another aspect of the disclosure, it is provided a computer program product comprising at least one non-transitory computer-readable storage medium having computer-executable program code stored therein, the computer-executable code being configured to, when being executed, cause an apparatus to operate according to any one of the above described methods.

These and other objects, features and advantages of the disclosure will become apparent from the following detailed description of illustrative embodiments thereof, which are to be read in connection with the accompanying drawings.

### BRIEF DESCRIPTION OF THE DRAWINGS

FIG. 1 depicts a flowchart of a method for malware detection according to an embodiment of the present disclosure;

FIG. 2 is a schematic diagram showing Android system call flow;

FIG. 3 depicts a flowchart of runtime data collection according to an embodiment of the present disclosure;

FIG. 4 depicts a flowchart for explaining the operations at a generation step of FIG. 1;

FIG. 5 depicts a flowchart for explaining the operations at a determination step of FIG. 1;

FIG. 6 depicts a flowchart of a method for malware detection according to another embodiment of the present disclosure;

FIG. 7 shows an exemplary system into which at least one embodiment of the present disclosure may be applied; and

FIG. 8 is a simplified block diagram showing an apparatus that is suitable for use in practicing some embodiments of the present disclosure.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

At present, mobile malware research is still in its infancy, even as malware authors shift their focus to smart phones. Few of the existing solutions can effectively detect mobile malware in a generic way with high accuracy. Some malicious mobile applications could intrude the mobile device suddenly after being used for a while. This threat challenges the research of mobile application trust.

Traditional methods for mobile malware detection can be classified into two types: static analysis methods and dynamic analysis methods. Static analysis is the way to find malicious characteristics or bad code segments in an application without executing them. Static analysis methods are generally used in a preliminary analysis, when suspicious applications are first evaluated to detect any obvious security threats. Dynamic analysis involves executing a mobile application in an isolated environment, such as a virtual machine or emulator, so that researchers can monitor the application's dynamic behavior.

However, both of the two methods have some disadvantages. The static analysis methods cannot exhaust all malicious features to achieve comprehensive detection. Further, the static analysis is hard to detect security threats caused by code execution, e.g., self-modifying after running and intrusion caused by a mobile botnet master or a botnet or a virus. The dynamic analysis methods often consume huge operating resources with low efficiency and detection accuracy. Further, dynamic detection requests mathematical modeling, but the mobile application software is very complex, which makes it hard to establish a complete mathematical model.

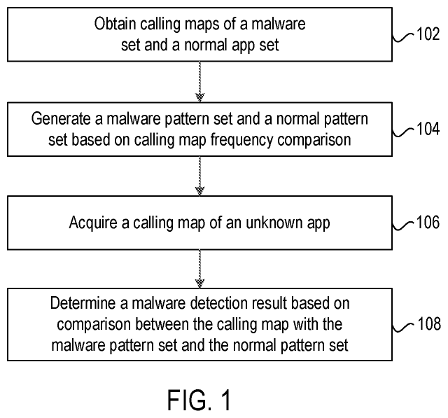

The present disclosure proposes a solution to detect mobile malware by making use of the advantages of both methods. According to an embodiment of the present disclosure, a dynamic method is used to collect the runtime data of applications by modifying the mobile operating system (OS) code (e.g., Linux kernel and the Android OS source code for Android devices). In this way, data about mobile application runtime system calls can be collected. After the completion of data collection, a static method is used to analyze the data. By comparing and analyzing the collected data of a set of malicious applications and normal applications, a malicious pattern set and a normal pattern set can be built up. For detecting an unknown mobile application, the unknown application's runtime data is collected, and target patterns are extracted and compared with the malicious pattern set and the normal pattern set in order to detect if the unknown application is malicious or normal. The solution can effectively find runtime problems and identify malware and normal applications in a generic way through a uniform detection process. However, it should be noted that the present disclosure is not limited to mobile malware detection. Those skilled in the art can understand that the principle of the present disclosure can also be applied to detect malware in any other computing device such as desktop, work station and so on. Hereinafter, the solution will be described in detail with reference to FIGS. 1-8.

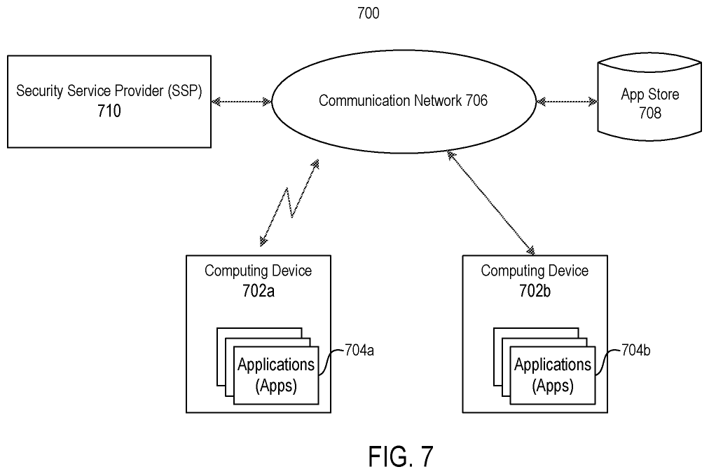

FIG. 1 depicts a flowchart of a method for malware detection according to an embodiment of the present disclosure. This method may be performed for example by a malware detection server (for example, a cloud server) at a security service provider (SSP) which will be described later with reference to FIG. 7. At step 102, calling maps of a malware set and a normal application set are obtained. The malware set may include a set of known malwares, and the normal application set may include a set of known normal applications. A calling map of an application comprises information about system call sequences of the application with different calling depth, wherein the calling depth is greater than or equal to one. That is, a system call sequence may represent an individual system call (i.e., the calling depth equals to one), or a series of sequential system calls (i.e., the calling depth is greater than one). The specific implementation of step 102 will be described below by taking Android OS as an example. However, those skilled in the art can understand that the principle of the present disclosure can also be applied to any other mobile OS such as iOS.

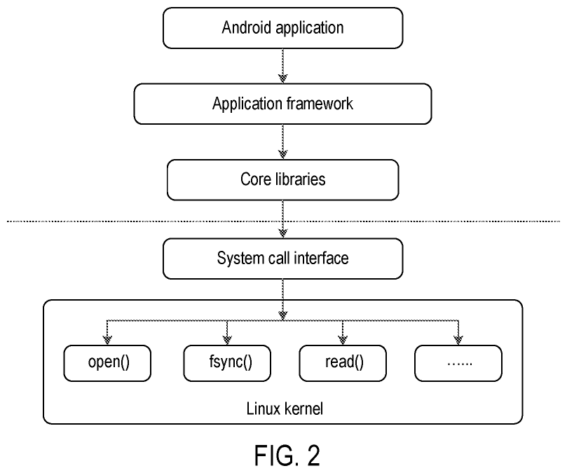

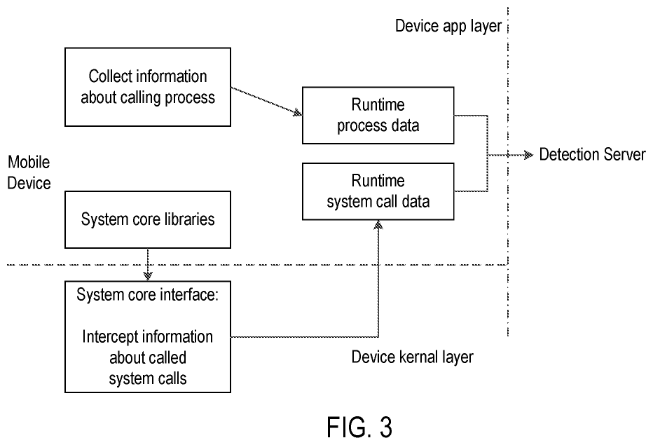

As an example, step 102 may be implemented as four sub-steps. At the first sub-step, an application in the malware set and the normal application set is run in a virtual environment. The virtual environment may be an application execution simulator such as Android monkey installed in the malware detection server. The application may be run for a period of time (for example, 2 hours). Then, at the second sub-step, information about called system calls is intercepted for the application. The information about called system calls may include at least the system calls' system call numbers through which names of the system calls can be determined. This sub-step may be implemented by modifying Android OS source code and Android kernel. To facilitate understanding, reference will be made to FIGS. 2-3.

FIG. 2 is a schematic diagram showing Android system call flow. As shown, Android OS uses Linux kernel to provide underlying drivers. All of Android applications use system calls to Linux kernel to control hardware such as WiFi module, storage, and camera. When an Android application has an operation, the Android OS converts the operation to a number of system calls to complete the operation. For example, when an Android application wants to read a file, the Android OS will use the system call open( ), read( ) to open the file and read the content of the file for displaying it on the screen.

In Android OS, the file entry_64.S is located at the system call interface layer, and is responsible for the system call distribution. It is an assembly source program with assembly functions. When an application has an operation, the Android OS translates its process id and system call number to the file entry_64.S, wherein the process id is the identification of the calling process that initiates the system call, and the system call number is the number of the system call that is called by the calling process. The process id and the system call number are put into a register by the file entry_64.S. In order to intercept the process id and the system call number, the register may be read in real time. The intercepted data may be sent from the kernel layer to the application layer as shown in FIG. 3, by using a net_link technology to write the intercepted data into a local file. This may be implemented by using inline assembly method to add C codes and assembly codes into the file entry_64.S and compiling the C codes together with the assembly codes in the modified file entry_64.S. It should be noted that the second sub-step of step 102 may also be implemented by using any existing technologies for collecting information about system calls.

Because there may be a lot of applications' processes being executed simultaneously, in order to identify the application to which the intercepted process id corresponds, information about calling process is collected at the third sub-step of step 102 as shown in FIG. 3. The information about calling process may include for example the process id and the process name of the calling process. From the process name, the name of the application to which the calling process belongs can be determined. This sub-step may be implemented by using any existing technologies for collecting information about calling process (for example, those open source programs utilizing ActivityManager). The collected information about calling process may also be recorded in a local file.

Then, at the fourth sub-step of step 102, a calling map is derived from the intercepted information and collected information. Since the intercepted information about called system calls and the collected information about calling process both include the process id, a system call and the application initiating the system call can be associated with each other, thereby the runtime system call data of each application in the malware set and the normal application set can be obtained. As an exemplary example, Table 1 shows the runtime system call data of an application called “WANYUEYUEDU”.

TABLE 1
Runtime system call data of “WANYUEYUEDU”

futex(0x5ad71590, 0x80 /* FUTEX_??? */, 0 <unfinished ...>
rt_sigtimedwait([QUIT USR1], <unfinished ...>
futex(0x41c85650, 0x80 /* FUTEX_??? */, 0 <unfinished ...>
ioctl(10, 0xc0186201 <unfinished ...>
recvmsg(44, <unfinished ...>
ioctl(10, 0xc0186201 <unfinished ...>
clock_gettime(CLOCK_MONOTONIC, {345751, 584922591}) = 0
...........

From Table 1, it can be seen that Android application's system calls are in sequence. In order to derive a calling map from the runtime system call data of an application, firstly, the system call names may be extracted for example by kicking out input parameters like “0x5ad71590, 0x80/*FUTEX_???*/, 0<unfinished . . . ” (see the first row of Table 1). In this way, the entire sequence of “WanYueYueDu” may be obtained as: futex->rt_sigtimedwait->futex->ioctl->recvmsg->ioctl->clock_gettime->. . . ->. . . ->.

Then, system call sequences with different calling depth may be searched from the entire sequence. For depth=1, a system call sequence represents an individual system call, and for the above example, the system call sequences may be obtained as: (futex, rt_sigtimedwait, futex, ioctl, recvmsg, ioctl, clock_gettime, . . . ). Because a system call sequence (e.g., futex) may appear multiple times in the entire sequence, a calling map may comprise at least information about the identification and appeared times of system call sequences. For depth=2, a system call sequence represents two sequential system calls, and for the above example, the system call sequences may be obtained as: (futex->rt_sigtimedwait, rt_sigtimedwait->futex, futex->ioctl, . . . ). For depth=3, a system call sequence represents three sequential system calls, and for the above example, the system call sequences may be obtained as: (futex->rt_sigtimedwait->futex, rt_sigtimedwait->futex->ioctl, futex->ioctl->recvmsg, . . . ). Likewise, system call sequences with depth=4, 5, 6, etc. may be obtained, until the depth reaches the maximum number N decided beforehand. Optionally, a calling map may comprise information about the frequency of a system call sequence, which is defined as the appeared times of a system call sequence divided by the total number of system call sequences with the same calling depth in an application. In this way, the calling map can be derived from the runtime system call data.

Further, because most malicious applications attempt to steal private information stored in device memory and cause malicious or abnormal traffic, the file and network system calls may be paid more attention. Thus, optionally, when deriving the calling map, the system call sequences related to file system operations and/or network access may be reserved, while the system call sequences that are irrelevant to file system operations and/or network access may be removed.

In the above example of step 102, the malware detection server runs the application, collects the runtime data and derives the calling map for the application. However, the present disclosure is not so limited. As another example, the runtime data may be collected by another device (for example, another desktop PC, server or mobile device), and the malware detection server may receive the runtime data from this device by using any existing data transmission technologies, and derive the calling map. As a further example, another device may collect the runtime data and derive the calling map, and the malware detection server may receive the calling map from this device.

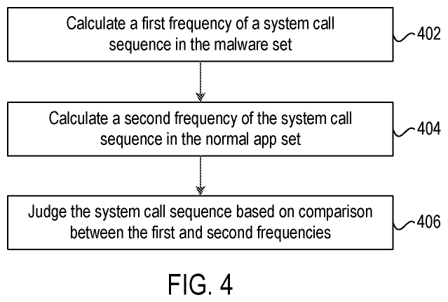

Then, at step 104, a malware pattern set and a normal pattern set are generated based on comparison between frequencies of the calling maps of the malware set and the normal application set. This step may be implemented as for example steps 402-404 of FIG. 4. At step 402, a first frequency of a system call sequence in the malware set is calculated. Because a system call sequence may appear in multiple applications in the malware set, the first frequency may be calculated as the average frequency of the system call sequence in the malware set.

Specifically, for an application in the malware set MS or the normal application set NS, if Tₖⁿ represents the appeared times of a system call sequence k with calling depth=n in the application and Hⁿ represents the total number of system call sequences with calling depth=n in the application, then the frequency Fₖⁿ of the system call sequence k with calling depth=n in the application may be calculated as:

Fₖⁿ=Tₖⁿ/Hⁿ.

As mentioned above, the frequency Fₖⁿ may be optionally included in the calling map. Further, if the total number of applications with the same system call sequence k with calling depth=n in the malware set is MNₖⁿ, then the average frequency MFₖⁿ of the system call sequence k with calling depth=n in the malware set may be calculated as:

$${MF}_{k}^{n} = ( {\sum }_{1}^{{MN}_{k}^{n}} {F}_{k}^{n} ) / {MN}_{k}^{n} .$$

Then, at step 404, a second frequency of the system call sequence in the normal application set is calculated. Because a system call sequence may appear in multiple applications in the normal application set, the second frequency may be calculated as the average frequency of the system call sequence in the normal application set.

Specifically, if the total number of applications with the same system call sequence k with calling depth=n in the normal application set is NNₖⁿ, then the average frequency NFₖⁿ of the system call sequence k with calling depth=n in the normal application set may be calculated as:

$${NF}_{k}^{n} = ( {\sum }_{1}^{{NN}_{k}^{n}} {F}_{k}^{n} ) / {NN}_{k}^{n} .$$

Then, at step 406, the system call sequence is judged as a malware pattern or a normal pattern, based on comparison between the first and second frequencies. As a simplest example, if the first frequency of a system call sequence is greater than its second frequency, it may be put into the malware pattern set; and if the second frequency of a system call sequence is greater than its first frequency, it may be put into the normal pattern set. As another example, if the ratio between the first frequency of a system call sequence and its second frequency is greater than a threshold, it may be put into the malware pattern set; and if the ratio is smaller than the threshold, it may be put into the normal pattern set.

As a further example, step 406 may be implemented as two sub-steps. At the first sub-step, when a first ratio MWₖⁿ between the first frequency MFₖⁿ and the second frequency

$${NF}_{k}^{n} = ( i . e . , {MW}_{k}^{n} = {MF}_{k}^{n} / {NF}_{k}^{n} )$$

is greater than a first threshold tm, the system call sequence k is judged as a malware pattern (i.e., the system call sequence k is put into the malware pattern set MP). The first ratio MWₖⁿ may be deemed as the weight of the system call sequence k in the malware pattern set MP. On the other hand, at the second sub-step, when a second ratio NWₖⁿ between the second frequency NFₖⁿ and the first frequency

$${MF}_{k}^{n} = ( i . e . , {NW}_{k}^{n} = {NF}_{k}^{n} / {MF}_{k}^{n} )$$

is greater than a second threshold tn, the system call sequence k is judged as a normal pattern (i.e., the system call sequence k is put into the normal pattern set NP). The second ratio NWₖⁿ may be deemed as the weight of the system call sequence k in the normal pattern set NP. In this way, the malware pattern set MP and the normal pattern set NP may be generated.

Each of tm and tn is a parameter greater than or equal to one. As an example, to obtain the optimal values for tm and tn, tm and tn may be increased stepwise from 1.0. For each pair of tm and tn, a pair of MP and NP may be obtained. For each pair of MP and NP, they may be used for detecting a set of sample applications. In this way, the values for tm and tn that correspond to the optimal detection accuracy (or the optimal tradeoff between the detection accuracy and the detection efficiency) may be obtained as the optimal values.

An exemplary algorithm for implementing step 406 may be represented as follows.

Input: MFₖⁿ of each k in MS, NFₖⁿ of each k in NS, where n =
1, 2, . . . N (e.g., N = 13) and k ∈ {system call sequences with
different depth}; tm: threshold to judge a malware detection pattern;
tn: threshold to judge a normal app pattern.
Output: malware pattern set MP and normal pattern set NP

```
      MP = NP = Φ;
      For ∀ k ∈ {system call sequences with different depth}
      $If {MW}_{k}^{n} = {MF}_{k}^{n} / {NF}_{k}^{n} > tm , put k into MP ,$
      $else if {NW}_{k}^{n} = {NF}_{k}^{n} / {MF}_{k}^{n} > tn , put k into NP .$
```

In the above described example, only those system call sequences that appear in both the malware set MS and the normal application set NS are considered to build up the malware pattern set MP and the normal pattern set NP. However, the present disclosure is not so limited. As a further example, for any system call sequence that only appears in MS or NS, if its frequency in MS or NS is sufficient high (for example, greater than a corresponding threshold), it may be put into MP or NP with its weight MWₖⁿ or NWₖⁿ being set to a preset high value.

Then, at step 106, a calling map of an unknown application is acquired. As an example, this step may be implemented as four sub-steps. At the first sub-step, in response to a sample of the unknown application from a mobile device, the sample is run in a virtual environment. At the second sub-step, information about called system calls is intercepted for the sample. At the third sub-step, information about calling process is collected for the sample. Then, at the fourth sub-step, a calling map is derived for the sample from the intercepted information and collected information. The specific implementations of these four sub-steps of step 106 are similar to those of step 102, and thus their detailed description is omitted here.

It should be noted that the present disclosure is not limited to the above example. As another example, the mobile device may collect the runtime data of the unknown application, which will be described later with reference to step 602. The malware detection server may receive the runtime data from the mobile device and derive the calling map from the received runtime data. As a further example, the mobile device may collect the runtime data of the unknown application and derive the calling map, which will be described later with reference to step 602. The malware detection server may receive the calling map from the mobile device.

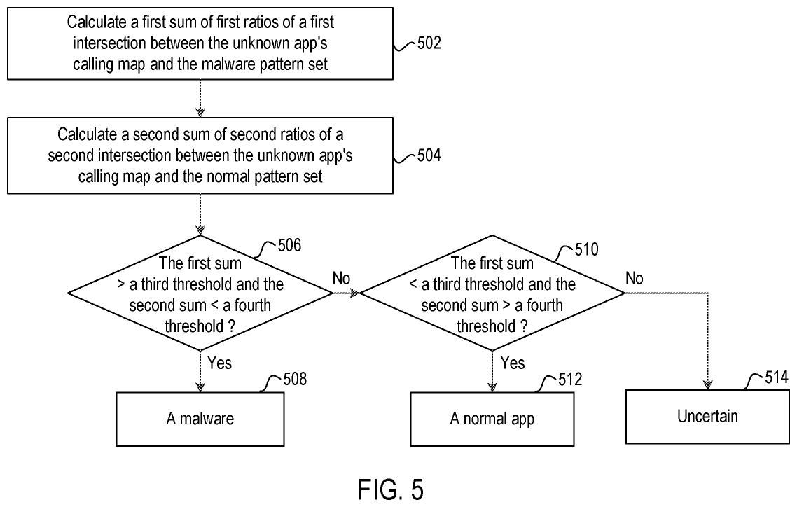

Then, at step 108, a malware detection result is determined for the unknown application, based on comparison between the unknown application's calling map with the malware pattern set and the normal pattern set. For instance, the malware detection result may be determined, based on the first and second frequencies of a first intersection between the unknown application's calling map and the malware pattern set and a second intersection between the unknown application's calling map and the normal pattern set. This may be implemented as steps 502-514 of FIG. 5.

At step 502, a first sum of the first ratios of the first intersection is calculated. That is, for the matched patterns between the unknown application's calling map and the malware pattern set MP, their weights MWₖⁿ are summed. At step 504, a second sum of the second ratios of the second intersection is calculated. That is, for the matched patterns between the unknown application's calling map and the normal pattern set NP, their weights NWₖⁿ are summed.

Then, at step 506, it is checked whether the first sum is greater than a third threshold Mt and the second sum is smaller than a fourth threshold Nt. If the check result at step 506 is positive (i.e., the first sum is greater than Mt and the second sum is smaller than Nt), the unknown application is determined as a malware at step 508. On the other hand, if the check result at step 506 is negative, it is checked whether the first sum is smaller than the third threshold Mt and the second sum is greater than the fourth threshold Nt at step 510.

If the check result at step 510 is positive (i.e., the first sum is smaller than Mt and the second sum is greater than Nt), the unknown application is determined as a normal application at step 512. On the other hand, if the check result at step 510 is negative (i.e., if the first sum is greater than Mt and the second sum is greater than Nt, or if the first sum is smaller than Mt and the second sum is smaller than Nt), the unknown application is determined as uncertain at step 514. That is, the unknown application's good or bad cannot be judged.

To obtain the optimal values for Mt and Nt, Mt and Nt may be changed within their corresponding ranges. For each pair of MP and NP, they may be used for detecting a set of sample applications. In this way, the values for Mt and Nt that correspond to the optimal detection accuracy (or the optimal tradeoff between the detection accuracy and the detection efficiency) may be obtained as the optimal values.

An exemplary algorithm for implementing steps 502-514 may be represented as follows.

```
Input: Fᵤₖⁿ of unknown app a for detection, where n=1, 2, ... N
(e.g., N = 13), uk ϵ {system call sequences of a}, Fᵤₖⁿ is the
frequency of uk with calling depth=n in the unknown
app a; Nt: the threshold of normal pattern matches, and over this
number implies the detected app is normal; Mt: the threshold of
malicious pattern matches, and over this number indicates the
detected app is suspected as malware; MP; NP.
Output: Detection result.
Qm = Qn = 0.
For ∀ uk ϵ {system call sequences of a },
  If uk = k, k ϵ MP, Qm = Qm + MWₖⁿ;
  Else if uk = k, k ϵ NP, Qn = Qn + NWₖⁿ.
If Qm > Mt and Qn < Nt, the app is malware.
If Qm < Mt and Qn > Nt, the app is normal.
If Qm > Mt and Qn > Nt, cannot judge the app's good or bad.
If Qm < Mt and Qn < Nt, cannot judge the app's good or bad.
```

It should be noted that the present disclosure is not limited to the above example. As another example, any other measures based on the first and second frequencies (for example, the sum of differences between the first and second frequencies of the first intersection, and the sum of differences between the second and first frequencies of the second intersection) may be used as the measures of the first and second intersection. As a further example, the ratio between the measures of the first intersection and the second intersection may be compared with a threshold. If the ratio is greater than the threshold, the unknown application may be judged as a malware, and if the ratio is smaller than the threshold, the unknown application may be judged as a normal application.

Optionally, the malware pattern set and/or the normal pattern set may be updated according to the malware detection result. As an example, when the unknown application is determined as a malware or a normal application, the malware pattern set and/or the normal pattern set may be updated by considering the unknown application as one of the applications in the malware set MS or the normal application set NS, and performing step 104 (e.g., steps 402-406) again.

In short, in the above described embodiment, a novel hybrid approach is proposed for malware detection in a generic way by adopting both dynamic analysis and static analysis. Execution data of a set of known sample malware and normal applications is collected to generate patterns of individual system calls and sequential system calls with different calling depth that are related to file, network access, and so on. By comparing the patterns (reflected by the above individual and sequential system calls) of malware and normal applications with each other, a malicious pattern set and a normal pattern set used for malware detection and normal application judge are built up. A malicious pattern is generated by calculating a first ratio between the average frequency of a sequential system call in the set of malware and the average frequency of the same sequential system call in the set of normal applications and deciding if the first ratio is above a first threshold. A normal pattern is generated by calculating a second ratio between the average frequency of a sequential system call in the set of normal applications and the average frequency of the same sequential system call in the set of malware and deciding if the second ratio is above a second threshold. When an unknown application needs to be detected, a dynamic method is used to collect its runtime system calling data about file and network access, and so on. Then the unknown application's target patterns of individual system calls and sequential system calls with different depth are extracted from its runtime system calling data. Then the target patterns are compared with the malicious pattern set and the normal pattern set in order to judge the unknown application's good or bad. The proposed method is a generic detection method suitable for various types of malware detection since the pattern set contains the patterns of various kinds of malware and normal applications. The malicious pattern set and the normal pattern set can be further optimized based on the patterns of newly confirmed malware and normal mobile applications

In the above described embodiment, a mobile device may send a sample of an unknown application to a malware detection server, and the malware detection server may determine a malware detection result for the unknown application. This is based on the consideration that the mobile computing and storage resources are generally limited. However, the present disclosure is not so limited. In a case where a mobile device has sufficient computing and storage resources, the method shown in FIG. 1 may also be performed by the mobile device.

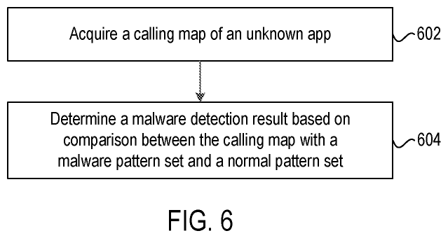

FIG. 6 depicts a flowchart of a method for malware detection according to another embodiment of the present disclosure. This method may be performed for example by a mobile device. At step 602, a calling map of an unknown application is acquired. As described above, a calling map of an application comprises information about system call sequences of the application with different calling depth, wherein the calling depth is greater than or equal to one. That is, a system call sequence may represent an individual system call (i.e., the calling depth equals to one), or a series of sequential system calls (i.e., the calling depth is greater than one). As an example, this step may be implemented as four sub-steps.

At the first sub-step, the unknown application is run in an isolated environment. The isolated environment may be implemented by using any existing sandbox technologies. At the second sub-step, information about called system calls is intercepted for the unknown application. At the third sub-step, information about calling process is collected for the unknown application. Then, at the fourth sub-step, a calling map is derived for the unknown application from the intercepted information and collected information. The specific implementations of the second sub-step to the fourth sub-step of step 602 are similar to those of step 102 or 106, and thus their detailed description is omitted here.

Then, at step 604, a malware detection result is determined for the unknown application, based on comparison between the calling map with a malware pattern set and a normal pattern set. The malware pattern set and the normal pattern set may be generated by a SSP (for example, a malware detection server) based on comparison between frequencies of calling maps of a malware set and a normal application set. The details about the generation of the malware pattern set and the normal pattern set have been described above with reference to steps 102-104 of FIG. 1, and thus are omitted here.

As an example, each pattern in the malware pattern set and the normal pattern set may have a first frequency in the malware set and a second frequency in the normal application set, which have been described above with reference to steps 402-404 of FIG. 4. Further, the malware detection result may be determined based on the first and second frequencies of a first intersection between the calling map and the malware pattern set and a second intersection between the calling map and the normal pattern set. This is similar to step 108 (for example, this may be implemented as steps 502-514 of FIG. 5), and thus its detailed description is omitted here.

Optionally, the malware detection result and the calling map of the unknown application may be sent to the SSP, such that the SSP can update the malware pattern set and/or the normal pattern set. As described above, when the unknown application is determined as a malware or a normal application, the SSP may update the malware pattern set and/or the normal pattern set by considering the unknown application as one of the applications in the malware set MS or the normal application set NS, and performing step 104 (e.g., steps 402-406) again.

In the above described embodiment, the mobile device may run an unknown application in an isolated environment to collect its runtime data, and determine a malware detection result for the unknown application. This is based on the case where the mobile device has sufficient computing and storage resources. However, the present disclosure is not so limited. The method shown in FIG. 6 may also be performed by a malware detection server at the SSP. In this case, the malware pattern set and the normal pattern set may be generated by another malware detection server. That is, the SSP can be located inside the system running the unknown application or in a remote detection server.

FIG. 7 shows an exemplary system into which at least one embodiment of the present disclosure may be applied. As shown, the system 700 comprises a computing device 702a having connectivity to an application store 708, a security service provider (SSP) 710, and other communication entities (such as other computing devices 702b) via a communication network 706. By way of example, the communication network 706 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), a self-organized mobile network, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), wireless local area network (WLAN), Long Term Evolution (LTE) networks, code division multiple access (CDMA), wideband code division multiple access (WCDMA), wireless fidelity (WiFi), satellite, mobile ad-hoc network (MANET), and the like.

The computing devices 702a, 702b (hereinafter referred as 702 in common) may be any type of devices capable of executing software applications, for example with a processor. For example, the computing devices 702 may be mobile devices such as smart phones, tablets and Personal Digital Assistants (PDAs), laptop computers, notebook, fixed devices such as station, multimedia computer, Internet node, desktop computer, embedded devices, or any combination thereof. As shown in FIG. 7, computing devices 702 may download applications 704a, 704b, from the application store 708, and execute the downloaded applications. Computing devices 702 may also be utilized to provide feedbacks of the usage of applications to the application store 708 or other entities.

The application store 708 may cache and manage various applications for upload, download, update, and the like. For example, for smart phones, there exists a plurality of application stores for different operating systems, such as Android system, iOS system and Windows Phone system. Although only one application store is shown in FIG. 7, any number of application stores may be provided.

The SSP 710 is provided for detecting application abnormities and malwares. In some embodiments, the SSP 710 may download an application from the application store 708. However, it should be understood that the SSP 710 may obtain execution codes of an application from any sources of applications, such as developers of software applications, enterprises, government organizations, users and/or other entities. The results of the malware detection may be issued to assist users for making decisions on application downloads. For example, there exist a plurality of enterprises or organizations that provide security services of software applications, such as F-secure, 360, etc. In some embodiments, the SSP 710 may be embodied as a server of such enterprises or organizations for checking securities of software applications or be deployed as a public or private cloud service that can be accessed by any other parties. In some embodiments, the SSP 710 may even be deployed at a computing device which is also capable of actually executing these applications by itself.

Based on the above description, the following advantageous technical effects can be achieved by the present disclosure:
(1) Hybrid solution: The proposed method benefits from the advantages of both static and dynamic analysis. The performance test conducted by the inventors only collected application runtime system call data for less than 2 hours and can reach high detection accuracy (over 90%), which implies that the proposed method is efficient for malware detection with high accuracy. Data may be processed at a PC server, which is much faster than in a mobile phone.
(2) Generality: The proposed method can be applied to detect various types of malware with different features since it applies both the malware pattern set and the normal pattern set for detection. If the pattern sets are trained with sufficient known samples, detection accuracy can be further improved. The performance test conducted by the inventors showed that the proposed method can detect different types of malware with higher accuracy than existing methods. In addition, the proposed method provides a uniform process to detect both malware and normal applications.
(3) Effectiveness: Malware patterns can be generated according to detection purpose. For example, for memory intrusion related malware, system calls about file system operations may be paid special attention; for network intrusion related malware, system calls about network access may be paid special attention. Even a new malware is created, the proposed method can still find out that it is not a normal one (e.g., cannot judge the good or bad of an application), and thereby additional detailed studies may be conducted thereon.
(4) Accuracy: Based on the performance test conducted by the inventors, the proposed method can achieve higher detection accuracy than existing methods with regard to different types of malware.
(5) Simple: The proposed method is simple. The data process is based on simple algorithms with low computation cost. It is suitable for malware detection based on big data.

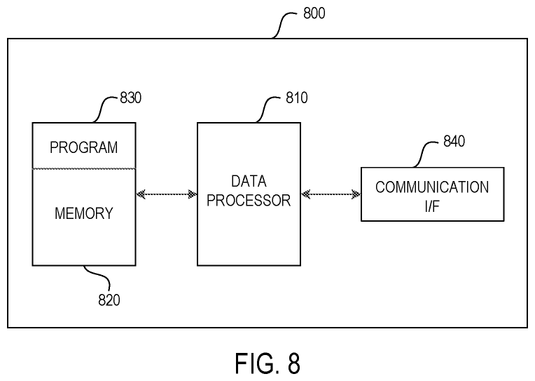

FIG. 8 is a simplified block diagram showing an apparatus that is suitable for use in practicing some embodiments of the present disclosure. For example, the malware detection server or the computing device may be implemented through the apparatus 800. As shown, the apparatus 800 may include a data processor 810, a memory 820 that stores a program 830, and a communication interface 840 for communicating data with other external devices through wired and/or wireless communication.

The program 830 is assumed to include program instructions that, when executed by the data processor 810, enable the apparatus 800 to operate in accordance with the embodiments of this disclosure, as discussed above. That is, the embodiments of this disclosure may be implemented at least in part by computer software executable by the data processor 810, or by hardware, or by a combination of software and hardware.

The memory 820 may be of any type suitable to the local technical environment and may be implemented using any suitable data storage technology, such as semiconductor based memory devices, flash memory, magnetic memory devices and systems, optical memory devices and systems, fixed memory and removable memory. The data processor 810 may be of any type suitable to the local technical environment, and may include one or more of general purpose computers, special purpose computers, microprocessors, digital signal processors (DSPs) and processors based on multi-core processor architectures, as non-limiting examples.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method comprising:
obtaining calling maps of a malware set and a normal application set, wherein a calling map comprises information about system call sequences with different calling depth greater than or equal to one;
generating a malware pattern set and a normal pattern set, based on comparison between frequencies of the calling maps of the malware set and the normal application set;
acquiring a calling map of an unknown application; and
determining a malware detection result for the unknown application, based on comparison between the unknown application's calling map with the malware pattern set and the normal pattern set.

2. The method according to claim 1, further comprising:
updating the malware pattern set and/or the normal pattern set according to the malware detection result.

3. The method according to claim 1, wherein the calling map is related to file system operations and/or network access.

4. The method according to claim 1, wherein the obtaining further comprises:
running an application in a virtual environment;
intercepting, for the application, information about called system calls;
collecting, for the application, information about calling process; and
deriving, for the application, a calling map from the intercepted information and collected information.

5. The method according to claim 1, wherein the acquiring comprises:
in response to a sample of the unknown application from a mobile device, running the sample in a virtual environment;
intercepting, for the sample, information about called system calls;
collecting, for the sample, information about calling process; and
deriving, for the sample, a calling map from the intercepted information and collected information.

6.-15. (canceled)

16. An apparatus comprising
at least one processor; and
at least one memory including computer program code;
the at least one memory and the computer program code configured to, with the at least one processor, cause the apparatus at least to:
obtain calling maps of a malware set and a normal application set, wherein a calling map comprises information about system call sequences with different calling depth greater than or equal to one;
generate a malware pattern set and a normal pattern set, based on comparison between frequencies of the calling maps of the malware set and the normal application set;
acquire a calling map of an unknown application; and
determine a malware detection result for the unknown application, based on comparison between the unknown application's calling map with the malware pattern set and the normal pattern set.

17. The apparatus according to claim 16, further comprising:
updating the malware pattern set and/or the normal pattern set according to the malware detection result.

18. The apparatus according to claim 16, wherein the calling map is related to file system operations and/or network access.

19. The apparatus according to claim 16, wherein, to obtain, the at least one memory and the computer program code are further configured to, with the at least one processor, cause the apparatus at least to:
run an application in a virtual environment;
intercept, for the application, information about called system calls;
collect, fr the application, information about calling process; and
derive, for the application, a calling map from the intercepted information and collected information.

20. The apparatus according to claim 16, wherein, to acquire, the at least one memory and the computer program code are further configured to, with the at least one processor, cause the apparatus at least to:
in response to a sample of the unknown application from a mobile device, run the sample in a virtual environment;
intercept, for the sample, information about called system calls;
collect, for the sample, information about calling process; and
derive, for the sample, a calling map from the intercepted information and collected information.

21. The apparatus according to claim 16, wherein, to generate, the at least one memory and the computer program code are further configured to, with the at least one processor, cause the apparatus at least to:
calculate a first frequency of a system call sequence in the malware set;
calculate a second frequency of the system call sequence in the normal application set; and
judge the system call sequence as a malware pattern or a normal pattern, based on comparison between the first and second frequencies.

22. The apparatus according to claim 21, wherein, to judge, the at least one memory and the computer program code are further configured to, with the at least one processor, cause the apparatus at least to:
judge the system call sequence as a malware pattern, when a first ratio between the first frequency and the second frequency is greater than a first threshold; and
judge the system call sequence as a normal pattern, when a second ratio between the second frequency and the first frequency is greater than a second threshold.

23. The apparatus according to claim 21, wherein, to determine, the at least one memory and the computer program code are further configured to, with the at least one processor, cause the apparatus at least to:
determine the malware detection result, based on the first and second frequencies of a first intersection between the unknown application's calling map and the malware pattern set and a second intersection between the unknown application's calling map and the normal pattern set.

24. The apparatus according to claim 23, wherein, to determine, the at least one memory and the computer program code are further configured to, with the at least one processor, cause the apparatus at least to:
calculate a first sum of the first ratios of the first intersection;
calculate a second sum of the second ratios of the second intersection;
determine the unknown application as a malware, when the first sum is greater than a third threshold and the second sum is smaller than a fourth threshold;
determine the unknown application as a normal application, when the first sum is smaller than the third threshold and the second sum is greater than the fourth threshold; and
determine the unknown application as uncertain, when the first sum is greater than the third threshold and the second sum is greater than the fourth threshold, or when the first sum is smaller than the third threshold and the second sum is smaller than the fourth threshold.

25. An apparatus comprising
at least one processor; and
at least one memory including computer program code;
the at least one memory and the computer program code configured to, with the at least one processor, cause the apparatus at least to:
acquire a calling map of an unknown application, wherein the calling map comprises information about system call sequences with different calling depth greater than or equal to one; and
determine a malware detection result for the unknown application, based on comparison between the calling map with a malware pattern set and a normal pattern set,
wherein the malware pattern set and the normal pattern set are generated by a security service provider (SSP) based on comparison between frequencies of calling maps of a malware set and a normal application set, and the SSP can be located inside a system running the unknown application or in a remote detection server.

26. The apparatus according to claim 25, wherein the at least one memory and the computer program code are further configured to, with the at least one processor, cause the apparatus at least to:
send the malware detection result and the calling map of the unknown application to the SSP, such that the SSP can update the malware pattern set and/or the normal pattern set.

27. The apparatus according to claim 25, wherein the calling map is related to file system operations and/or network access.

28. The apparatus according to claim 25, wherein, to acquire, the at least one memory and the computer program code are further configured to, with the at least one processor, cause the apparatus at least to:
run the unknown application in an isolated environment;
intercept, for the unknown application, information about called system calls;
collect, for the unknown application, information about calling process; and
derive, for the unknown application, a calling map from the intercepted information and collected information.

29. The apparatus according to claim 25, wherein each pattern in the malware pattern set and the normal pattern set has a first frequency in the malware set and a second frequency in the normal application set; and
wherein, to determine, the at least one memory and the computer program code are further configured to, with the at least one processor, cause the apparatus at least to:
determine the malware detection result, based on the first and second frequencies of a first intersection between the calling map and the malware pattern set and a second intersection between the calling map and the normal pattern set.

30. The apparatus according to claim 29, wherein, to determine, the at least one memory and the computer program code are further configured to, with the at least one processor, cause the apparatus at least to:
calculate a first sum of first ratios of the first intersection, the first ratio being a ratio between the first frequency and the second frequency of a pattern;
calculate a second sum of second ratios of the second intersection, the second ratio being a ratio between the second frequency and the first frequency of a pattern;
determine the unknown application as a malware, when the first sum is greater than a third threshold and the second sum is smaller than a fourth threshold;
determine the unknown application as a normal application, when the first sum is smaller than the third threshold and the second sum is greater than the fourth threshold; and
determine the unknown application as uncertain, when the first sum is greater than the third threshold and the second sum is greater than the fourth threshold, or when the first sum is smaller than the third threshold and the second sum is smaller than the fourth threshold.

31.-33. (canceled)
